(19) United States
(12) Patent Application Publication
(10) Pub. No.: US 2007/0115814 A1
(43) Pub. Date: May 24, 2007

(54) Method and apparatus for improved data transmission

(75) Inventors: Mario Gerla, Santa Monica, CA (US); M. Yahya Sanadidi, Santa Monica, CA (US); Giovanni Pau, Los Angeles, CA (US); Ren Wang, Tigard, OR (US); Alex Balk, Dallas, TX (US); Dario Maggiorini, Milano (IT); Kenshin Yamada, Kanagawa (JP); Rohit Kapoor, San Diego, CA (US); Ling-Jyh Chen, Taipei (TW)

Correspondence Address: CHRISTIE, PARKER & HALE, LLP, PO BOX 7068, PASADENA, CA, 91109-7068, US

(73) Assignee: REGENTS OF THE UNIVERSITY OF CALIFORNIA, THE, Oakland, CA (US)

(21) Appl. No.: 10/550,806

(22) PCT Filed: Mar. 29, 2004
(86) PCT No.: PCT/US04/09645

§ 371 Date: Dec. 13, 2006

Related U.S. Application Data
(60) Provisional application No. 60/458,886, filed on Mar. 29, 2003.
(60) Provisional application No. 60/473,842, filed on May 28, 2003.
(60) Provisional application No. 60/510,864, filed on Oct. 14, 2003.
(60) Provisional application No. 60/515,750, filed on Oct. 30, 2003.
(60) Provisional application No. 60/515,751, filed on Oct. 30, 2003.
(60) Provisional application No. 60/527,856, filed on Dec. 8, 2003.

(51) Int. Cl. H04L 12/26

(52) U.S. Cl. 370/230; 370/468

(57) ABSTRACT

Methods and apparatuses for improved data transmission control protocols. Acknowledgment streams are used by a sender process to generate various estimates of eligible transmission rates that are fair to other processes competing for bandwidth across a common network. In addition, the acknowledgment streams are used in conjunction with various other standard transmission control protocol metrics to adapt a filter for use on the rate estimates. Additional improvements in throughput may no be had by measuring the overall capacity of the computer network using packet pair dispersion measurements and adaptive network probing. In addition, the methods may be adapted for both packet transmission and video streaming applications.

### BACKGROUND OF THE INVENTION

This invention pertains generally to data transmission protocols and more specifically to optimizing transmission rates in the presence of network congestion.

The Transmission Control Protocol (TCP) provides end-to-end, reliable, congestion controlled connections over the Internet. The congestion control method used originally in TCP Tahoe included two phases: slow-start and congestion avoidance. In TCP Reno, recovery from sporadic packet losses is enhanced by fast retransmission and fast recovery. SACK-based TCPs provide the sender with more complete information about which packets are lost. Another class of algorithms is referred to as “NewReno” which does not need SACK information and requires only modification on the sender side. Research shows that the majority of TCP implementations are NewReno. Therefore, TCP Westwood and its refinement variants were implemented with NewReno as a base.

Increasingly, TCP is called upon to provide reliable and efficient data transfer over a variety of link technologies including wired and wireless with increasing bandwidth capacity. The new ultra high speed wired/wireless environment is exceeding the range for which TCP was initially designed, tested and tuned. As a consequence, active research is in progress to extend the domain of effective TCP operability. The use of path conditions estimate for enhancing congestion control in TCP has been proposed, termed TCP Vegas. In TCP Vegas, the sender infers the network congestion level from observed changes in Round Trip Time (RTT). If RTT becomes large, the source will decrease its congestion window (cwnd), thus reducing its transmission rate. However, new arriving connections to a congestion in progress may not be able to get a fair share of the bottleneck bandwidth. In a packet pair scheme, a sender estimates the bottleneck backlog and adjusts its sending rate accordingly. However, the packet pair scheme explicitly assumes round-robin scheduling at the routers—a feature not available in many commercial routers. Several network and link-layer enhancements have also been proposed to improve TCP performance under various conditions (congestion loss, random loss, handoff, out of order delivery, etc.), such as random early detection, Explicit Congestion Notification (ECN), and Explicit Loss Notification (ELN).

TCP Westwood (TCPW) design adheres to the end-to-end transparency guidelines and requires only sender side modification. The key innovation of TCP Westwood is to use a bandwidth estimate directly to drive a congestion window (cwin) and a slow start threshold (ssthresh) settings. The current estimation method in TCP Westwood is based on Bandwidth Estimation (BE). This TCP Westwood BE strategy provides significant throughput gains, especially the large leaky pipes. However, under certain congestion circumstances, BE exceeds the fair share of a connection resulting in possible unfriendliness to TCP New Reno connections.

The current implementation of TCP Reno/NewReno mainly includes two phases: Slow-start and Congestion-avoidance. In the Slow-start phase, a sender opens the congestion window (cwnd) exponentially, doubling cwnd every Round-Trip Time (RTT) until it reaches the Slow-start Threshold (ssthresh). The connection switches then to Congestion-avoidance, where cwnd grows more conservatively, by only 1 packet every RTT (or linearly). The initial ssthresh is set to an arbitrary default value, ranging from 4K to 64K Bytes, depending on the operating system implementation.

By setting the initial ssthresh to an arbitrary value, TCP performance may suffer from two potential problems: (a) if ssthresh is set too high relative to the network Bandwidth Delay Product (BDP), the exponential increase of cwnd generates too many packets too fast, causing multiple losses at the bottleneck router and coarse timeouts, with significant reduction of the connection throughput; (b) if the initial ssthresh is set low relative to BDP, the connection exits Slow-start and switches to linear cwnd increase prematurely, resulting in poor startup utilization especially when BDP is large.

Recent studies reveal that a majority of the TCP connections are short-lived (mice), while a smaller number of long-lived connections carry most Internet traffic (elephants). A short-lived connection usually terminates even before it reaches “steady state”. That is, before cwnd grows to make good utilization of the path bandwidth. Thus, the startup stage can significantly affect the performance of the mice. In a large BDP network, with the current Slow-start scheme, it takes many RTTs for a TCP connection to reach the ideal window (equal to BDP). For example, in current Reno/NewReno implementation with initial ssthresh set to 32 Kbytes, a TCP connection takes about 100 sec to reach the ideal window over a path with a bottleneck bandwidth of 100 Mbps and RTT of 100 ms. The utilization in the first 10 sec is a meager 5.97%. With the rapid development of the Internet and ever-growing BDP, a more efficient Slow-start mechanism is required to achieve good link-utilization.

A variety of methods have been suggested to avoid multiple losses and achieve higher utilization during the startup phase. A larger initial cwnd, roughly 4K bytes, has been proposed. This could greatly speed up transfers with only a few packets. However, the improvement is still inadequate when BDP is very large, and the file to transfer is bigger than just a few packets. Fast start uses cached cwnd and ssthresh in recent connections to reduce the transfer latency. The cached parameters may be too aggressive or too conservative when network conditions change.

Smooth start [WXRS] has been proposed to slow down cwnd increase when it is close to ssthresh. The assumption here is that default value of ssthresh is often larger than the BDP, which is no longer true in large bandwidth delay networks. In one proposed solution, the initial ssthresh is set to the BDP estimated using packet pair measurements. This method can be too aggressive. In another proposed method, termed Shared Passive Network Discovery (SPAND), has been proposed to derive optimal TCP initial parameters. SPAND needs leaky bucket pacing for outgoing packets, which can be costly and problematic in practice.

TCP Vegas detects congestion by comparing the achieved throughput over a cycle of length equal to RTT, to the expected throughput implied by cwnd and baseRTT (minimum RTT) at the beginning of a cycle. This method is applied in both Slow-start and Congestion-avoidance phases. During Slow-start phase, a Vegas sender doubles its cwnd only every other RTT, in contrast with Reno's doubling every RTT. A Vegas connection exits slow-start when the difference between achieved and expected throughput exceeds a certain threshold. However, Vegas may not be able to achieve high utilization in large bandwidth delay networks because of its over-estimation of RTT.

In addition to the general problems associated with conventional digital data transmission, other protocols are needed for optimization of specific types of data transport such as streaming video. The increasing popularity of streaming video is a cause for concern for the stability of the Internet because most streaming video content is currently delivered via User Datagram Protocol (UDP), without any end-to-end congestion control. Since the Internet relies on end systems implementing transmit rate regulation, there has recently been significant interest in congestion control mechanisms that are both fair to TCP and effective in delivering real-time streams.

### SUMMARY OF THE INVENTION

Methods and apparatuses for improved data transmission control protocols. Acknowledgment streams are used by a sender process to generate various estimates of eligible transmission rates that are fair to other processes competing for bandwidth across a common network. In addition, the acknowledgment streams are used in conjunction with various other standard transmission control protocol metrics to adapt a filter for use on the rate estimates. Additional improvements in throughput may be had by measuring the overall capacity of the computer network using packet pair dispersion measurements and adaptive network probing. In addition, the methods may be adapted for both packet transmission and video streaming applications.

In one aspect of the invention, ACKnowledments (ACKs) are used to estimate a connection rate share. The estimate of connection rate share is then used to directly set congestion control parameters by a transmission control process.

In another aspect of the invention, a rate sample is obtained when an ACK arrives using information in the ACK regarding the delivered bytes and the last two ACKs inter-arrival time. The samples are then exponentially averaged to produce smoothed rate estimates using a filter with time varying coefficients.

In another aspect of the invention, two estimators are maintained by a transmission control process to set cwin and ssthresh. The transmission control process uses the estimators to identify the predominant cause of packet loss using a loss discrimination algorithm. The loss discrimination algorithm relies on a ratio of expected throughput to achieved throughput. If this ratio exceeds a threshold (a parameter of this method), the loss discrimination algorithm declares the packet loss to be resulting from congestion and therefore chooses an estimate based on an interval of length T, which is another parameter of this method. If on the other hand, the ratio of expected to achieved throughput is below the threshold, the loss is assumed to be the result of an error, and the sample interval is taken to be the last ACK inter-arrival time. The samples are exponentially averaged and filtered to produce smoothed eligible rate estimates.

In another aspect of the invention, depending on the outcome of the loss discrimination algorithm, an appropriate estimator is used to set cwin and ssthresh. Both estimators use information obtained from ACKs received at the sender. One estimator, a Bandwidth Estimator (BE), considers each ACK pair separately to obtain a bandwidth sample, filters the samples into a low pass filter and returns as a result the available bandwidth that the TCP connection is estimated to be getting from the network. The other estimator, a Rate Estimator (RE), considers the amount of data acknowledged during the latest interval of time T as sampled, then feeds such samples into an appropriate low pass filter to get the estimated rate, in this case tending to estimate the throughput that the TCP Westwood connection has recently experienced. This method of using two estimators is herein termed Combined Rate and Bandwidth estimation (CRB).

In another aspect of the invention, the CRB method uses the relationship between the current cwin value and the estimated pipe size, the latter indicated by the product of RE and a minimum RTT (RTTmin). When RE*RTTmin is significantly smaller than cwin, it is more likely that packet losses are because of congestion. This is because the connection is using a cwin value much higher than its share of pipe size, thus congestion is likely. In CRB, whenever a packet loss is indicated, the sender determines the predominant cause of loss as follows: when the ratio RE*RTTmin to cwin exceeds a threshold value θ, the use of RE is indicated. Below θ, BE is indicated.

In another aspect of the invention, a packet loss is indicated either by a reception of 3 duplicate ACKs (DUPACKs) or a coarse timeout. The CRB method sets ssthresh and cwin after a packet loss indicated by three DUPACKs. If cwin divided by RE*RTTmin divided by the TCP segment size is greater than θ, then a congestion condition is indicated and ssthresh is set to RE*RTTmin divided by the TCP segment size. Otherwise, ssthresh is set to BE*RTTmin divided by the TCP segment size. After ssthresh is adjusted, then cwin is compared to ssthresh. If cwin is greater than ssthresh then cwin is set to ssthresh.

In another aspect of the invention, an adaptive method is used to estimate the rate a connection is eligible to use. The estimation is adapted to the perceived congestion level in such a way that the resulting estimate provides both higher efficiency as in the method above, as well as friendliness to other traffic types sharing the network path. Under packet loss because of congestion, the resulting eligible rate estimate is conservative, and thus improves friendliness by accommodating other traffic types sharing the network resources. Under low congestion, a packet loss is assumed to be the result of random error. The resulting eligible rate estimate is more aggressive, improving efficiency under random loss.

In another aspect of the invention, herein termed Adaptive Bandwidth Share Estimation (ABSE), the sample interval T is continuously adapted to the perceived network congestion level. The sample interval can be as small as the latest ACK inter-arrival time, and can grow in a continuous manner up to the estimated minimum round trip time of the connection. The congestion level is determined from the difference between the expected throughput and the achieved throughput of the connection. The samples are exponentially averaged and filtered to produce the eligible rate estimate. The eligible rate estimate is then used to set cwin and ssthresh as before.

In one aspect of the invention, a method, herein termed Adaptive Start (Astart) is used at start up, or after a timeout occurs. In Astart, when a connection initially begins or re-starts after a coarse timeout, Astart adaptively and repeatedly resets the TCP Slow start Threshold (ssthresh) based on an Eligible Rate Estimation (ERE), as calculated in TCPW. Using ERE provides the means for adapting to network conditions during the startup phase. Thus a sender is able to grow the congestion window (cwnd) quickly without incurring risk of buffer overflow and multiple losses. AStart can significantly improve link utilization under various bandwidth, buffer size and round trip propagation times. Most importantly, the method avoids both link under utilization due to premature Slow start termination, as well as multiple losses due to initially setting ssthresh too high, or increasing cwnd faster than appropriate.

In TCPW, a sender calculates ERE as previously described and then uses ERE during the congestion avoidance phase of TCP as follows:

```
if (3 DUPACKS are received)
  ssthresh = (ERE*RTTmin)/seg_size;
  if (cwnd >ssthresh)  /*congestion avoid*/
    cwnd=ssthresh;
  endif
endif
if (coarse timeout expires)
  cwnd = 1;
  ssthresh =(ERE *RTTmin)/seg_size;
  if(ssthresh < 2)
    ssthresh = 2;
  endif
endif
```

In Astart, a sender calculates ERE and uses ERE during start up or after a Timeout as follows:

```
if ( 3 DUPACKS are received)
  switch to congestion avoidance phase;
else (ACK is received)
  if (ssthresh < (ERE*RTTmin)/seg_size)
      ssthresh =(ERE*RTTmin)/seg_size;
  endif
  if (cwnd >ssthresh)  /*mini congestion avoid. phase*/
    increase cwnd by 1/RTT;
  else if cwnd <ssthresh)  /*mini slow start phase*/
    increase cwnd by 1;
  endif
endif
```

This mode of operation can be extended to the entire lifetime of the connection, thus protecting also against random errors and sudden increases of bottleneck bandwidth, as may occur with nomadic users.

In another aspect of the invention, the principles of rate control for packet transmissions are applied to streaming video protocols. Such streaming video protocols attempt to maximize the quality of real-time video streams while simultaneously providing basic end-to-end congestion control. A Video Transport Protocol (VTP) uses receiver-side bandwidth estimation. Such estimation is transmitted to the source and enables the source to adapt to network conditions by altering the source's sending rate and the bitrate of the transmitted video stream. VTP delivers consistent quality video in moderately congested networks and fairly shares bandwidth with TCP in all but a few extreme cases.

In another aspect of the invention, VTP adapts an outgoing video stream to the characteristics of the network path between sender and receiver. If a VTP sender determines there is congestion, the VTP sender reduces its sending rate and the video encoding rate to a level the network can accommodate. This enables a VTP sender to deliver a larger portion of the overall video stream and to achieve inter-protocol fairness with competing TCP traffic.

In another aspect of the invention, a VTP sender makes several trade-offs to limit processing overhead and buffering requirements in the receiver. In general, a VTP sender sparingly uses bandwidth and memory during the streaming session.

### BRIEF DESCRIPTION OF THE DRAWINGS

These and other features, aspects, and advantages of the present invention will become better understood with regard to the following description, appended claims, and accompanying drawings where:

FIG. 1 is an equation for a current rate estimator in accordance with an exemplary embodiment of the present invention;

FIG. 2 is an equation for a rate estimator for a previous rate estimator in accordance with an exemplary embodiment of the present invention;

FIG. 3 is an equation for a current rate estimator using a previous rate estimator in accordance with an exemplary embodiment of the present invention;

FIG. 4 is an equation for a filtered rate estimator in accordance with an exemplary embodiment of the present invention;

FIG. 5 is a pseudocode listing for a TCP control process in accordance with an exemplary embodiment of the present invention;

FIG. 6 is a pseudocode listing for a TCP control process using an adaptive bandwidth share estimate in accordance with an exemplary embodiment of the present invention;

FIG. 7 is a data flow diagram depicting an adaptive bandwidth share estimation process in accordance with an exemplary embodiment of the present invention.

FIG. 8 is a process flow diagram of a bandwidth estimation process in accordance with an exemplary embodiment of the present invention;

FIG. 9 illustrates a VTP video header in accordance with an exemplary embodiment of the present invention;

FIG. 10 illustrates a VTP and acknowledgment or “control packet” format in accordance with an exemplary embodiment of the present invention;

FIG. 11 is a diagram of a sender Finite State Machine (FSM) controlling video rate transmission in accordance with an exemplary embodiment of the present invention;

FIG. 12 is a software architecture diagram of a VTP sender and receiver in accordance with an exemplary embodiment of the present invention; and

FIG. 13 is a block diagram of a computing device suitable for hosting a transmission protocol control process or video transport protocol process in accordance with an exemplary embodiment of the present invention.

### DETAILED DESCRIPTION

To identify the predominant cause of packet loss, ECN and ELN can be used. However, ECN requires all the routers along a network path to support ECN, while ELN has its share of implementation problems as reported in. Instead, a method to identify the predominant cause of packet loss may be used that does not require support from lower layers. The method uses the relationship between the current congestion window value and the estimated pipe size, the latter being defined as the product of RE and the minimum RTT observed. The pipe size corresponds to the ideal window required to achieve the rate RE. When the measured pipe size is significantly smaller than cwin, it is very likely that packet losses are due to congestion.

TCP design aims to utilize all available bandwidth, while maintaining fairness in the allocations made to different flows. Fairness is achieved by equally allocating the available bandwidth to active TCP flows, unless some of them are inherently unable to use their share regardless of the existence of competing flows. For instance, on a leaky large pipe, NewReno utilization is dramatically reduced. In this case, a flow using a new proposed protocol can achieve higher bandwidth share and preserve fairness. However, this should be accomplished without reduction in the legacy connections throughput. Fair bandwidth share may be defined for the following cases:
a) for N TCP Westwood flows sharing a bottleneck link with capacity C, the fair share is C/N;
b) for a total of N TCP Westwood and TCP NewReno flows, assuming that no random errors are possible, both protocols are roughly equivalent, and therefore the fair share for each flow is C/N;
c) Assuming that there are random errors on the paths (e.g. from a wireless link) to which all flows are subjected. Because TCP NewReno flows are inherently unable to utilize the link capacity in this case, TCP Westwood flows should not be considered aggressive by getting a larger bandwidth share than the NewReno flows. We define the fair share of a NewReno flow as the same value if all flows are TCP NewReno. For instance, suppose the fair share of the NewReno flow is Sᵣ given that there are total N homogenous TCP NewReno flows, then when this total N flows includes some TCP Westwood flows, the fair share of NewReno flow should remain Sᵣ, while TCP Westwood flows could have a fair share of higher value. Thus, a TCP Westwood fair share can be higher than a NewReno share since the latter connection is inherently incapable of using the link capacity.
d) In the presence of nonadaptive high priority flows (e.g, real time streaming traffic) which take away a portion of bandwidth determined by their transmission rates, the capacity available to TCP connections is reduced by the amount used by the nonadaptive flows and fair share is calculated for a TCP Westwood connection as in the above three cases.

In TCP Westwood, the BE estimator is used to drive cwnd and ssthresh determination. This protocol has been shown to achieve a high utilization when used over large leaky pipes. In certain cases, BE may overestimate its fair share. In this case, TCP NewReno (and other TCP like protocols) may experience performance degradation. TCP Westwood Rate Estimation (RE) addresses the issue of friendliness to NewReno. Both estimations are based on the ACK arrival process received by the. TCP W sender; thus, they are passive and introduce no extra link overhead.

A TCP Westwood sender uses ACKs to estimate BE. More precisely, the sender uses the following information: (1) the ACK reception rate; and (2) the information an ACK conveys regarding the amount of data recently delivered to the destination.

Significant efficiency improvements are obtained using the BE estimator produced by the sampling and filtering methods above. This is particularly true in environments with large leaky pipes. Further, note that when routers employ around robin policy in scheduling transmissions, BE is accurate in estimating a connection fair share. However, for drop tail routers, since TCP traffic tends to be “bursty”, i.e. sending out a full window of packets and then waiting for the acknowledgments, BE may over estimate the connection fair share.

Consider an alternative bandwidth sample, defined as the amount of data reported to be delivered by all ACKs that arrived in the last T time units, divided by T. This method is herein termed Rate Estimation (RE). This alternative is identical to the earlier TCP Westwood sample definition if the ACKs are uniformly spaced in time. Simulation and measurements, however, show that ACKs tend to cluster in bursts. Thus, the BE sampling method “overestimates” the connection fair share, while providing (in the bursty case) a reasonably good estimate of the available bandwidth at the bottleneck. Thus, BE is more effective in environments with random error, and when single connection efficiency is paramount.

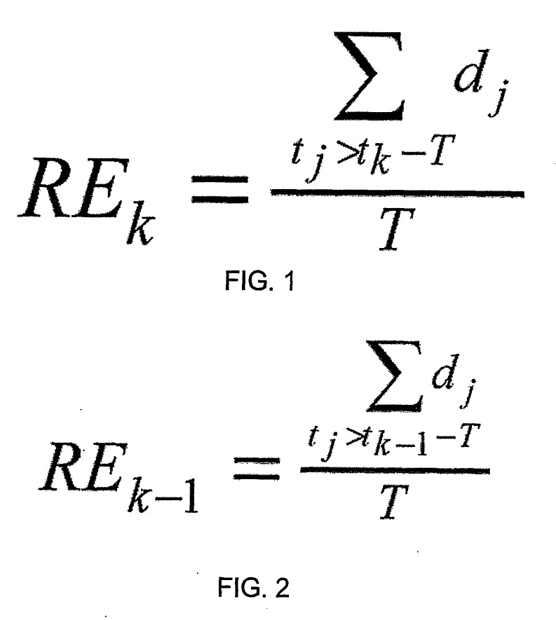

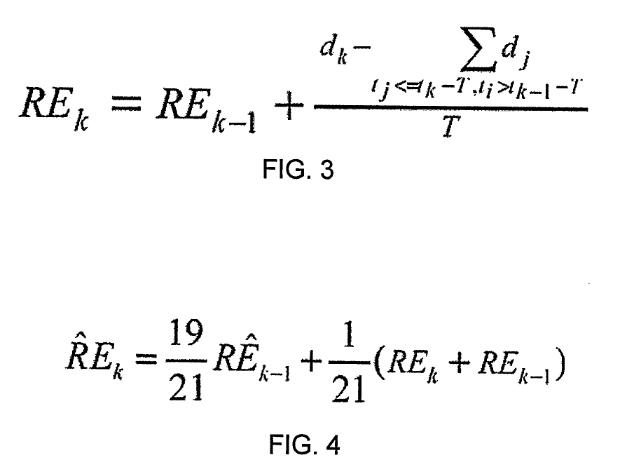

The REₖ sample associated with the kₜₕ received ACK is expressed by the equation in FIG. 1, where: dⱼ is the amount of data reported by ACK j and at any instant, a sliding window of length T is used to obtain a bandwidth sample. Similarly, at the previous time instant, k−1, the sample, REₖ₋₁, is given by the equation in FIG. 2. Therefore, the RE associated with the kₜₕ received ACK can be determined from the RE associated with the k−1 received ACK as given in the equation in FIG. 3. Thus, The expression in FIG. 3 is a recursive one, because the sample is calculated using its previous value as a reference. Additionally, the technique places equal emphasis on all data points in the sampling range. Thus a value in the near past will have the same influence as a more current measurement when calculating the sample. This is a desirable feature when dealing with bursty TCP traffic in the presence of congestion. Finally, sliding window samples are exponentially averaged in order to obtain a smoothed bandwidth share estimate over time. A simple exponential averaging filter to calculate the RE at the instant the kₜₕ ACK is received, RÊₖ is given by the equation in FIG. 4.

BE is more effective than RE as an estimate in environments with random error. On the other hand, the RE method is more appropriate when packet losses are because of congestion (router buffer overflow). Based on the tradeoff presented above, a hybrid method that combines both sampling strategies would be of interest, provided one can determine the cause of packet loss: errors or buffer overflow. This issue of course is beyond the sampling methodology investigation itself. In fact, if a sender were able to distinguish with certainty between error and buffer overflow losses, the sender reaction to the former would be to retransmit immediately with no change of window size.

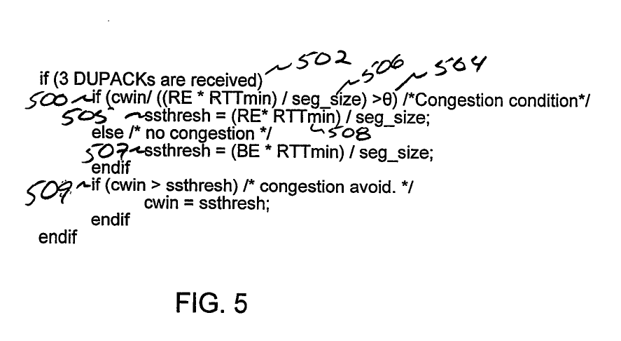

FIG. 5 is a pseudocode listing for a TCP control process using setting ssthresh and cwin in accordance with an exemplary embodiment of the present invention. The process may be used to determine the predominant cause of packet loss requiring no assistance from layers below TCP. The method is herein termed Combined Rate and Bandwidth estimation (CRB). The CRB method uses the relationship between the current cwin value and the estimated pipe size, the latter indicated by the product of RE and the minimum RTT. When RE*RTTmin (500) is significantly smaller than cwin, it is more likely that packet losses are because of congestion. This is because the connection is using a cwin value much higher than its share of pipe size, thus congestion is likely. In CRB, whenever a packet loss is indicated by the reception of three duplicate ACKS (502), the sender determines the predominant cause of loss as follows: when the ratio RE*RTTmin to cwin exceeds a threshold value θ (504), the use of RE to reset ssthresh is indicated (505). Below θ, BE is indicated (507) to reset ssthresh. A threshold of θ=1.4 was found to give the satisfactory results.

A packet loss is indicated either by a reception of 3 DUPACKs or a coarse timeout. The CRB method sets ssthresh and cwin (509) after a packet loss indicated by three duplicate ACKS. In the pseudocode, seg_size 506 identifies the length of a TCP segment in bits. The value RTTmin 508 is set as the smallest RTT estimated by a TCP process, using its own RTT estimation method. The basic Reno behavior is still captured, while setting ssthresh to the value of BE or RE, as appropriate, provides a more rational recovery.

In another aspect of the invention, the TCPW sender adaptively determines a Bandwidth Share Estimate (TCPW ABSE). As such, TCPW ABSE is then a sender only modification of TCP NewReno. The estimate is based on information in the ACKs, and the rate at which the ACKs are received. After a packet loss indication, which could be because of either congestion or link errors, the sender uses the estimated bandwidth to properly set the congestion window and the slow start threshold.

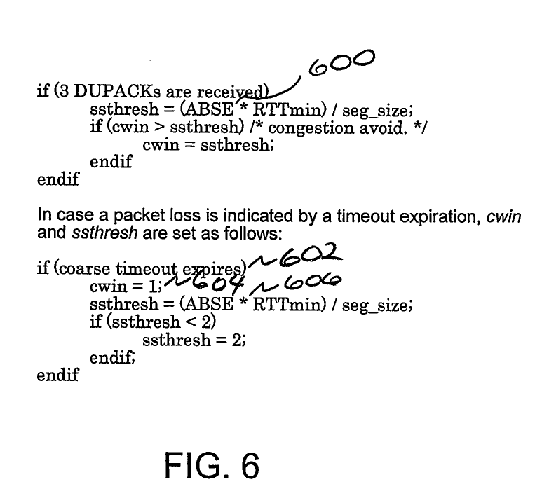

FIG. 6 is a pseudocode listing for a TCP control process using an adaptive bandwidth share estimate in accordance with an exemplary embodiment of the present invention. In TCP ABSE, a sender determines a connection bandwidth estimate 600 as described below and uses the bandwidth estimate to set cwin and ssthresh after a packet loss indication. The rationale of the algorithm above is that after a timeout (602), cwin and the ssthresh are set equal to 1 (604) and ABSE (606), respectively. Thus, the basic Reno behavior is still captured, while a reasonably speedy recovery is ensured by setting ssthresh to the value of ABSE.

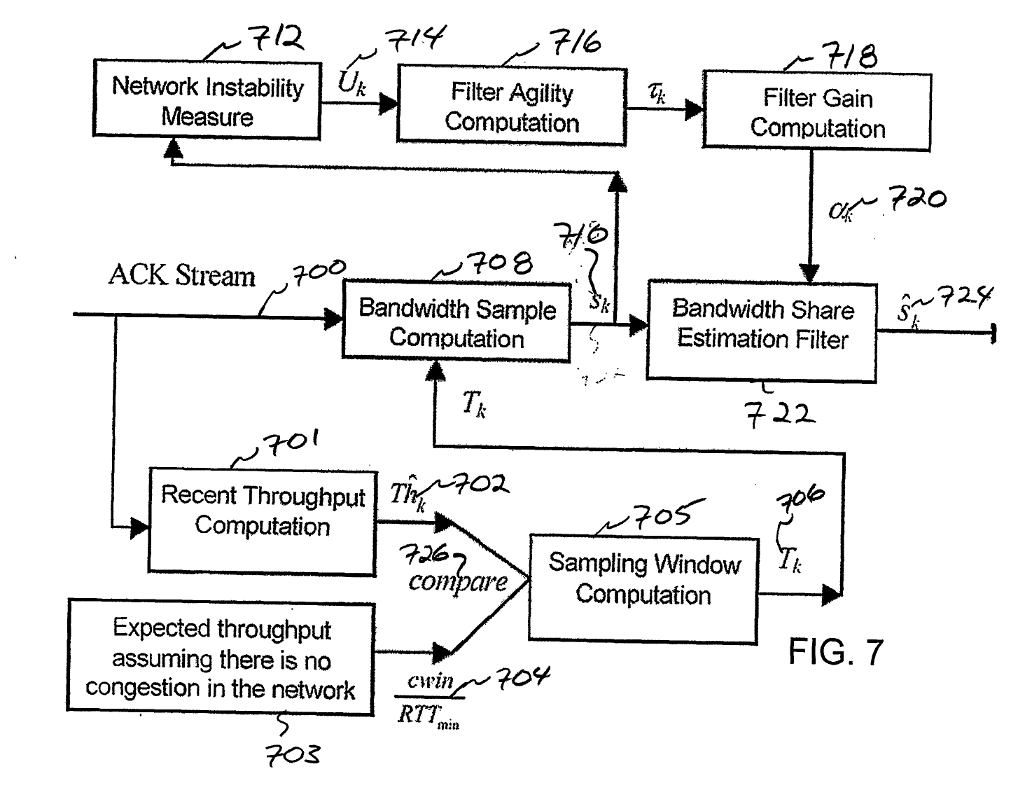

FIG. 7 is a data flow diagram depicting an adaptive bandwidth share estimation process in accordance with an exemplary embodiment of the present invention. An ACK stream 700 is received by the process and used to generate (701) a recent throughput sample 702. The recent throughput sample is used in conjunction with a generated (703) expected throughput 704 to generate (705) a sampling time interval 706. The time interval is then used in conjunction with the ACK stream to generate (708) an unfiltered bandwidth share sample 710. The unfiltered bandwidth share sample is used to generate (712) a network instability measure 714 which is filtered (716 and 718) to generate a filter gain 720. The filter gain is used in conjunction with the unfiltered bandwidth share sample to generate (722) a filtered adaptive bandwidth share estimate 724.

Bandwidth share estimates or EREs are determined using a time-varying coefficient Exponentially-Weighted Moving Average (EWMA) filter which has both adaptive gain and adaptive sampling. Let tₖ be the time instant at which the kₜₕ ACK is received at the sender. Let sₖ be the ERE sample, and ŝₖ the filtered estimate of the ERE at time tₖ. Let αₖ be the time-varying coefficient at tₖ. The ABSE filter is then given by:
Ŝᵢ=αᵢŜᵢ₋₁+(1−αᵢ)sᵢ

Where

$${α}_{k} = \frac{2 {τ}_{k} - Δ {t}_{k}}{2 {τ}_{k} + Δ {t}_{k}}$$

and τₖ is a filter parameter which determines the filter gain, and varies over time by adapting to RTT and other path conditions.

The value of the parameter αₖ, dictates the degree of filtering. The smaller αₖ, the more agile the filter, and the larger αₖ, the more stable the filter. In addition, when τₖ is larger, αₖ will be larger and the filter tends to be more stable and less agile. In BE, the sender sets τ to a fixed constant, which is used by all TCP connections initiated by this sender, despite any variance in their RTT and path instability. One aspect of this setting is if τ is too large, the filter will be very slow in following the change of path conditions. In an ABSE process, the parameter τₖ adapts to network conditions to dampen estimates when the network exhibits very unstable behavior, and react quickly to persistent changes. A stability detection filter can be used to dynamically change the value of τₖ.

One way to measure the network instability U is with a time-constant EWMA filter given by:
Uₖ=βUₖ₋₁+(1−β)|sₖ−sₖ₋₁|

Where sₖ is the kₜₕ rate sample and β is the gain of the filter. When the network exhibits high instability, the consecutive rate observations diverge from each other, as a result, Uₖ increases. Under this condition, increasing the value of τₖ makes the ABSE filter more stable.

When a TCP connection is operating normally, the interval between the consecutive acknowledgements are likely to vary between the smallest the bottleneck capacity allows, and one RTT. Therefore, τₖ should be larger than one RTT, thus τₘᵢₙ=RTT. The formula for calculating τₖ is:

$${τ}_{k} = RTT + N * RTT \frac{{U}_{k}}{{U}_{max}}$$

In the above expression, the value of RTT is obtained from a smoothed RTT estimated in a TCP process. The factor N maybe set to 10, which gives good performance under various scenarios. Uₘₐₓ is the largest instability determined from the ten most recent instability observations. The τₖ adaptation algorithm described above is able to achieve agility to persistent changes while retaining stability against noise.

In the filter formula above, the ERE sample at time k is:

$${S}_{k} = \frac{{\sum }_{{t}_{j} > {t}_{k} - {T}_{k}} {d}_{j}}{{T}_{k}}$$

where dⱼ is the number of bytes that have been reported delivered by the jₜₕ ACK, and Tₖ is an interval over which the ERE sample is calculated.

In the above-described CRB process, a transmission control process switches between RE and BE, after identifying whether the predominant cause of packet loss is error or congestion. The interval T over which RE is calculated is fixed, and the discriminator of cause of loss relies on a threshold mechanism θ. When the ratio of expected traffic to achieved rate exceeds the threshold θ, and a loss is detected, the predominant cause of loss is estimated to be congestion.

To preserve both efficiency and fairness, an ABSE process uses a continuously adaptive sampling interval T. The more severe the congestion, the longer T should be. An ABSE process provides an adaptive sampling scheme in which the time interval Tₖ associated with the Kₜₕ received ACK is appropriately chosen between two extremes, Tₘᵢₙ and Tₘₐₓ, depending on the network congestion level. Tₘᵢₙ is the ACK interarrival time, while Tₘₐₓ is set to RTT.

To determine the network congestion level, the ABSE estimator compares (726 of FIG. 7) the ERE with the instantaneous sending rate obtained from cwin/RTTₘᵢₙ. A measure of the path congestion level is thus obtained. The difference between the instantaneous sending rate and the achievable rate, clearly feeds the bottleneck queue, thus revealing that the path is becoming congested. The larger the difference, the more severe the congestion, and the larger the new value of Tₖ should be. When the kth ACK arrives, the estimator first checks the relation between ERE estimate ŝₖ₋₁ and the current cwin value. When ŝₖ−1 RTTₘᵢₙ≧cwin, indicating a path without congestion, Tₖ is set to Tmin. Otherwise, Tₖ is set to:

$${T}_{k} = RTT * \frac{cwin - ( {\hat{s}}_{k - 1} * {RTT}_{min} )}{cwin}$$

In TCPW, the sender continuously monitors ACKs from the receiver and computes its current ERE. Such an ERE relies on an adaptive estimation technique applied to ACK stream. The goal of ERE is to estimate the eligible sending rate for a connection, and thus achieving high utilization without starving other connections. Research on active network estimation reveals that samples obtained using packet pairs often reflects physical bandwidth, while samples obtained using a long packet train gives short-time throughput estimates. Not having the luxury to estimate using active probing packets, a TCPW sender carefully chooses sampling intervals and filtering techniques to estimate the eligible bandwidth share of a connection. DUPACKs and delayed ACKs are also properly counted in ERE computation.

In another TCP process in accordance with an exemplary embodiment of the present invention, when the kₜₕ ACK arrives, a sample of throughput during the previous RTT is calculated as:

$$T {h}_{k} = {\sum }_{{t}_{j} > {t}_{k} - RTT} {d}_{j} / RTT$$

where dⱼ is the amount of data reported by ACK j. This sample of throughput is used as above in determining the time period Tₖ as above.

In current TCPW implementation, upon packet loss (indicated by 3 DUPACKs or a timeout) the sender sets cwnd and ssthresh based on the current ERE. TCPW uses the following algorithm to set cwnd and ssthresh:

```
if (3 DUPACKS are received)
    ssthresh = (ERE*RTTmin)/seg_size;
    if (cwnd >ssthresh)  /*congestion avoid*/
        cwnd=ssthresh;
    endif
endif
if (coarse timeout expires)
    cwnd = 1;
    ssthresh =(ERE *RTTmin)/seg_size;
    if(ssthresh < 2)
        ssthresh = 2;
    endif
endif
```

Adaptive Start (Astart), improves TCP startup performance. AStart takes advantage of the ERE mechanism used in TCPW and adaptively and repeatedly resets ssthresh during a slow-start phase. When ERE indicates that there is more available capacity, the connection opens its cwnd faster, enduring better utilization. On the other hand, when ERE indicates that the connection is close to steady state, it switches to congestion-avoidance, limiting the risk of buffer overflow and multiple losses. As such, AStart significantly enhances performance of TCP connections, and enhancement increases as BDP increases. When BDP reaches around 750 packets, the throughput improvement is an order of magnitude higher than that of TCP Reno/NewReno for short-lived connections.

AStart is a sender-side only modification to the traditional Reno/NewReno slow start algorithm. The TCPW eligible rate estimate is used to adaptively and repeatedly reset ssthresh during the startup phase, both connection startup, and after every coarse timeout. The pseudo code of the algorithm is as follows. When an ACK arrives:

```
if ( 3 DUPACKS are received)
    switch to congestion avoidance phase;
else (ACK is received)
    if (ssthresh < (ERE*RTTmin)/seg_size)
        ssthresh =(ERE*RTTmin)/seg_size;
    endif
    if (cwnd >ssthresh)  /*mini congestion avoidance phase*/
        increase cwnd by 1/RTT;
    else if cwnd <ssthresh)  /*mini slow start phase*/
        increase cwnd by 1;
    endif
endif
```

In TCPW, an eligible rate estimate is determined after every ACK reception. In Astart, when the current ssthresh is much lower than ERE, the sender resets ssthresh higher accordingly, and increases cwnd in slow-start fashion. Otherwise, cwnd increases linearly to avoid overflow. In this way, Astart probes the available network bandwidth for this connection, and allows the connection to eventually exit Slow-start close to the ideal window. Compared to Vegas, TCPW avoids premature exit of slow start since it relies on both RTT and ACK intervals, while Vegas only relies on RTT estimates.

By applying Astart, the sender does not overflow a bottleneck buffer and thus multiple losses are avoided. In effect, Astart consists of multiple mini-slow-start and mini-congestion-avoidance phases. Thus, cwnd does not increase as quickly as other methods, especially as cwnd approaches BDP. This prevents the temporary queue from building up too fast, and thus, prevents a sender from overflowing a small buffer. In Astart, cwnd increase follows a smoother curve when it is close to BDP. In the case of a plurality of connections, each connection is able to estimate its share of bandwidth and switch to congestion-avoidance at the appropriate time. In addition, Astart has a more appropriate (lower) slow-start exit cwnd, because of the continuous estimation mechanism, which reacts to the new traffic and determines an eligible sending rate that is no longer the entire bottleneck link capacity.

In one embodiment of the invention, a bandwidth or capacity estimate is made using packet pair dispersion measurements. This capacity estimation technique, herein termed “CapProbe”, is based on the observation that a packet pair measurement corresponding to either an over-estimated or an under-estimated capacity suffers cross-traffic induced queuing at some link. Exploiting this observation, CapProbe is a technique combining dispersion and delay measures to filter out packet pair samples that were “distorted” by cross-traffic.

Relying on packet pair dispersion to estimate path capacity may lead to either under-estimation or over-estimation of capacity. Over-estimation occurs when the narrow link is not the last one on the path, i.e., when so-called post narrow links are present. The presence of these links can reduce the packet pair dispersion created by the narrow link if the first packet of the pair queues at a post-narrow link, while the second does not (or experiences queuing for a shorter time than the first packet). In this case, the dispersion between the packet pair is smaller than that created by the narrow link, leading to an over-estimation of capacity. Note that the queueing of the first packet in this case is caused by interference from cross-traffic. This behavior, termed “compression” by various researchers, is more pronounced when the probe packets are smaller than cross-traffic packets and as the cross-traffic rates increase. The key observation here is that when capacity over-estimation happens, the first packet of the packet pair will have queued at a post-narrow link due to interference from cross-traffic.

Under-estimation occurs when cross-traffic packets are served (transmitted) in between packets of the packet pair samples. This increases the dispersion of the packet pair and leads to a lower capacity estimation. This under-estimation of capacity is more pronounced as the cross-traffic rate increases, and when the underlying expansion of the dispersion is not counter-balanced by compression after the narrow link.

The key observation here is that when under-estimation occurs, the second packet of the packet pair will have queued due to interference from cross-traffic. Note that the second packet can also experience queuing delay due to the first packet. Such delay is different from that induced due to cross-traffic and does not distort the dispersion.

CapProbe is based on the association of increased queuing delay (resulting from cross-traffic) with capacity estimation errors as discussed above. CapProbe combines dispersion as well as delay measurements of packet pair probes. Using both dispersion and delay together, CapProbe provides accurate capacity estimates.

When packet dispersion under-estimates or over-estimates capacity, at least one packet of the packet pair involves cross-traffic induced queuing. Thus, whenever an incorrect value of capacity is estimated, the sum of the delays of the packet pair packets includes cross-traffic induced queuing delay. On the other hand, when the correct value of capacity is estimated, it is not necessary for either packet of the packet pair to experience cross-traffic induced queuing delay. Of course, even when dispersion estimates capacity correctly, both packets of the packet pair could be delayed due to cross-traffic by the same amount. In this case, dispersion will measure capacity accurately, but delays of packets will include cross-traffic induced queuing delay.

The CapProbe technique is based on the assumption that at least one sample of the packet pairs goes through without cross-traffic interference, resulting in at least one sample that measures the correct capacity and does not experience cross-traffic queuing. The sum of delays of the two packet pair packets for this sample will not involve any cross-traffic queuing delay. This sum will, thus, be the minimum value for the sum of the delays of the two packets among all packet pair samples.

CapProbe calculates the sum of delays of the two packets for all samples of the packet pair. The dispersion measured from the sample corresponding to the minimum over all “delay sums” reflects the narrow link capacity.

To illustrate, consider the set of packet pair samples, i=0, 1, 2 . . . Let dᵢ represent the ‘delay sum’, i.e., the sum of the delays of the first and second packets of the packet pair i. Let L be the size of the packet pair packets.

The dispersion τⱼ for a packet pair sample is defined as the difference between the delays of the two packets of the packet pair sample. CapProbe determines the minimum dⱼ for subset of samples, having equal value of sample dispersion τₖ. Let the minimum delay obtained be dₖ. Thus:
dₖ=min {dⱼ, for all i such that τᵢ=τₖ}

CapProbe is based on the assumption that at least one packet pair sample with the appropriate minimum dₖ is received at the destination. In a network such as the Internet in which the traffic intensity varies due to reactive TCP flows, there is very high likelihood of obtaining one or more of the desired samples.

In another embodiment of the invention, capacity probing is performed using other network metrics. In TCPW, ERE is only used to set sshthresh and cwnd after a packet loss. ERE may be further employed when linear increase is too slow to ramp up cwnd, as in cases of connection start-up and dynamic bandwidth as aforementioned. A technique, herein termed Agile Probing (TCPW-A), is a sender-side only enhancement of TCPW, that deals well with highly dynamic bandwidth, large propagation times and bandwidth, and random loss in the current and future heterogeneous Internet. TCPW-A achieves this goal by incorporating the following two mechanisms into the basic TCPW algorithm.

The first mechanism is Agile Probing, which is invoked at connection start-up (including after a time-out), and after extra available bandwidth is detected. Agile Probing adaptively and repeatedly resets ssthresh based on ERE. Each time the ssthresh is reset to a value higher than the current one, cwnd climbs exponentially to the new value. This way, the sender is able to grow cwnd efficiently (but conservatively) to the maximum value allowed by current conditions without overflowing the bottleneck buffer with multiple losses -a problem that often affects traditional TCP. The result is fast convergence of cwnd to a more appropriate ssthresh value. In Slow Start, Agile Probing increases utilization of bandwidth by reaching “cruising speed” faster than existing protocols, this is especially important to short-lived connections.

The second mechanism concerns how to detect extra unused bandwidth. If a TCP sender identifies the newly materialized extra bandwidth and invokes Agile Probing properly, the connection can converge to the desired window faster than usual linear increase. This also applies in the case when a random error occurs during start-up, causing a connection to exit Slow Start prematurely and switch to Congestion Avoidance. A Persistent Non-Congestion Detection (PNCD) mechanism identifies the availability of persistent extra bandwidth in congestion avoidance, and invokes Agile Probing accordingly.

In Slow Start, Agile Probing is always used, while in congestion avoidance Agile Probing is invoked only after PNCD detects persistent non-congestion. Agile Probing uses ERE to adaptively and repeatedly reset ssthresh. During Agile Probing, when the current ssthresh is lower than ERE, the sender resets ssthresh higher accordingly, and increases cwnd exponentially. Otherwise, cwnd increases linearly to avoid overflow. In this way, Agile Probing probes the available network bandwidth for this connection, and allows the connection to eventually exit Slow-start close to an ideal window corresponding to its share of path bandwidth. The pseudo code of the algorithm, executed upon ACK reception, is as follows:

```
if (DUPACKS are received)
    switch to congestion avoidance phase;
else (ACK is received)
    if(ssthresh < (ERE*RTTmin)/seg_size)
        ssthresh = (ERE*RTT min)/seg_size;/*reset
ssthresh */
    endif
    if(cwnd >=ssthresh) /*linear increase phase*/
        increase cwnd by l/cwnd;
    else if (cwnd <ssthresh) /*exponentially increase  phase*/
        increase cwnd by 1;
    endif
endif
```

By repeating cycles of linear increase and exponential increase, cwnd adaptively converges to the desired window in a timely manner, enhancing link utilization in Slow Start.

PNCD is a mechanism that aims at detecting extra available bandwidth and invoking Agile Probing accordingly. In congestion avoidance, a connection monitors the congestion level constantly. If a TCP sender detects persistent non-congestion conditions, which indicates that the connection may be eligible for more bandwidth, the connection invokes Agile Probing to capture such bandwidth and improve utilization.

As described above, RE is an estimate of the rate achieved by a connection. If the network is not congested and extra bandwidth is available, RE will increase as cwnd increases. On the other hand, if the network is congested, RE flattens despite of the cwnd increase.

As mentioned before, cwnd/RTT min indicates an expected rate in no congestion and RE is the achieved rate. To be more precise, RE is the achieved rate corresponding to the expected rate 1.5 times RTT earlier. Thus, as used in a comparison, the corresponding expected is (cwnd−1.5)/RTTₘᵢₙ. RE tracks the expected rate in non-congestion conditions, but flattens, remaining close to the initial expected rate (ssthresh/RTTₘᵢₙ) under congestion. A congestion boundary is defined as:
CongestionBoundary=β*ExpectedRate+(1−β)*InitialExpectedRate
where 0<β<1.

RE may fluctuate crossing above and below the Ccongestion boundary. To detect persistent non-congestion, a non-congestion counter is used, which increases by one every time RE is above the Congestion Boundary and decreases by one if RE is below the Congestion Boundary. A pseudo code of the PNCD algorithm is as follows:

```
if(in Congestion Avoidance except for initial two RTT){
    if( RE >Congestion Boundary){
        no_congestion_counter++;
    else if(no congestion_counter> O){
        no_congestion_counter −−;
    if(no_congstion_counter > cwnd){
        re-start Agile Probing;
    }else{
    no_congestion_counter=0;
    }
```

If the parameter β is greater than 0.5, the congestion boundary line gets closer to expected rate. The algorithm can be made more conservative by setting β>0.5.

Even if the PNCD algorithm accurately detects non-congestion, there is always the possibility that the network becomes congested immediately after the connection switches to Agile Probing phase. One such scenario is after a buffer overflow at the bottleneck router. Many of the TCP connections may decrease their cwnd after a buffer overflow, and congestion is relieved in a short time period. The PNCD in some connection may detect non-congestion and invoke Agile Probing. However, the erroneous detection is not a serious problem. Unlike exponential cwnd increase in Slow Start phase of NewReno, the TCP connection adaptively seeks the fair share estimate in Agile Probing mode. Thus, if the network has already been congested when a new Agile Probing begins, the “Agile Probing” connection will not increase cwnd much, and will go back to linear probing quickly.

Implementation of the forgoing congestion avoidance and startup mechanisms within TCPW may require collection of session metrics depending on specific TCP implementations for a particular computer platform. The following is a discussion of an implementation of TCPW ABSE protocol on Free BSD 4.4. Specifically, additional issues are addressed in the implementation relating to cumulative ACK handling, out of sequence ACKs, and CPU clock granularity.

A TCPW ABSE Protocol estimates the bandwidth by determining the difference in ACK sequence numbers between two packets. Care is taken to handle reordering and duplicate ACKs. When a source node receives a reordered packet which has smaller ACK sequence number than the previous packet, the sender can not predict how many bytes the destination node received in the corresponding time period. One solution is to identify and then ignore the reordered packets. The source maintains the maximum sequence number of ACK packets, and if the ACK sequence number of the received packet is less than the maximum one, the source assumes that the ACK is a reordering packet and the source ignores the ACK. If the maximum sequence number becomes too large due to some error, all packets are treated as reordering packets. To avoid this improper situation, the source node enforces the rule that the maximum sequence number never exceeds the maximum sequence number of packets that have ever been sent.

The TCPW ABSE Protocol estimates the bandwidth as a difference of ACK sequence number divided by a difference of receiving time between two packets. If the source receives a duplicate ACK, a TCPW source process may not be able to calculate the amount of bytes received. To solve this problem, an expected ACK sequence number is introduced instead of the real ACK sequence number. The TCPW source assumes that a duplicate ACK packet corresponds to an average TCP segment size. The expected sequence number is increased by the average TCP segment size. The average size is calculated as an exponential averaging of sending packets. In a similar manner as calculation of the maximum ACK sequence number, such a rule ensures the expecting sequence number never exceeds the maximum sequence number of the packet that has ever been sent.

The CPU clock cycle in FreeBSD is called a “tick”. The default unit of a tick is 10 mSec. This low granularity may causes several problems. One potential problem is that several packets can be received at the same time unit. When several packets are received at the same time unit, the TCPW source may not be able to estimate the bandwidth between these packets because the time interval is 0 mSec. Therefore, in this implementation, the TCPW source uses the first received packet in each tick to calculate bandwidth.

Additional benefits are had by using one packet for each tick. For example, a TCPW source only needs to calculate bandwidth once per tick. This reduces the CPU load in high speed connections. Another benefit is that a TCPW source only needs to accommodate one ACK packet information per tick. This reduces the size of a buffer for storing ACK packet information. However, a TCPW source needs to take care with the effects of neglecting the packets in the same tick.

A TCPW ABSE source needs to keep a ACK information, such as sequence number and receiving time, to calculate the bandwidth sample. The maximum time interval for storing ACK information is determined by the sampling interval T. The maximum value of T is one RTT. Thus, the number of packets needs to be stored: N is calculated as:
N=MaximumWindowSize/PacketSize

For example, if the TCPW source assumes that the MaximumWindowSize is 64 kbytes and the PacketSize is 512 bytes, the TCPW source transmits 128 packets. However, if the TCPW source wants to achieve the high throughput in a large RTT like 45 Mbps in RTT=70 mSecs, the MaximumWindowSize should be more than 3 Mbytes, and N should be more than 6 kbytes.

Fortunately, due to 10 mSec ticks restriction, the TCPW source needs only to accommodate one packet for each tick unit. Thus, the TCPW source can calculate N as:
N=RTT/TickPeriod
where TickPeriod is 10 mSec in this implementation.

In this way, N may be determined regardless of throughput. If the TCPW source sets N=256, the TCPW source can support TCP connections with less than 2.5 sec RTT. Though 2.5 Sec RTT is large enough in the current Internet, the TCPW source also needs to handle a connection with more than 3 Sec RTT. To support a very long RTT, a new parameter is introduced in the TCPW implementation. The new parameter is a minimum time interval for storing ACK information. This minimum time interval is changed adaptively based on RTT so that the TCPW source can accommodate all packets within T without changing N.

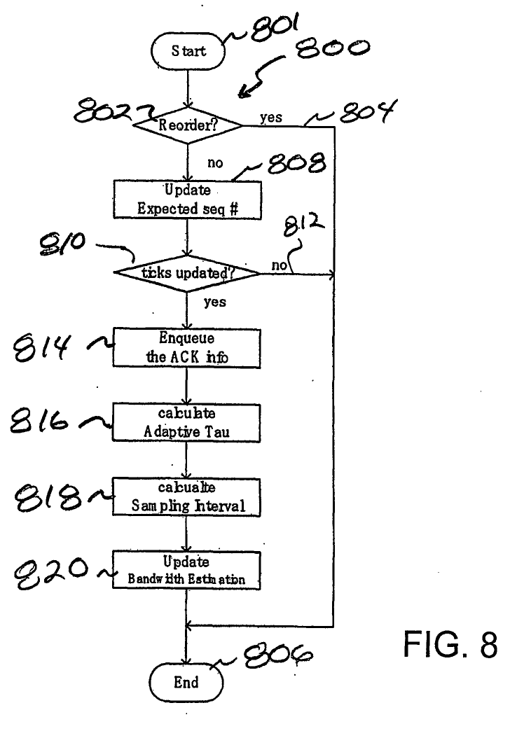

FIG. 8 is a process flow diagram of a bandwidth estimation process in accordance with an exemplary embodiment of the present invention. A bandwidth estimation process 800 is called (801) whenever an ACK packet is received. If the bandwidth estimation process determines that the packet is reordered 802, the calculation is cancelled 804 and terminates (806). Otherwise, the bandwidth estimation process updates (808) the expected sequence number. The bandwidth estimation process checks the receiving time to determine (810) if the ticks have been updated. If the current packet is received at the same tick as a previously stored packet, the calculation is cancelled (812). Otherwise, the bandwidth estimation process stores (814) the expected sequence number and receiving time in an ACK information array. The bandwidth estimation process uses the stored ACK information to calculate (816) filter gain adaptation parameters, Uₖ and ABSE filter parameter τₖ as previously described. Uₘₐₓ is calculated as the maximum instability in the ten most recent observations. Uₘₐₓ may possibly become 0, which causes a 0 division error. In this case, τₖ is defined as τₖ=RTT if Uₘₐₓ=0.

The bandwidth estimation process calculates (818) an adaptive sampling interval when the source receives a packet. Bandwidth sampling is computed based on the amount of data acknowledged during the interval T. T is calculated as previously described. Finally, the bandwidth estimation process updates (820) a bandwidth estimation using the ACK information array, using the oldest and newest ACK during the interval T, and calculating the sample bandwidth Sₖ and the estimated bandwidth ŝₖ as previously described. If T is less than or equal to 0 or there are only one ACK during the time interval T, the bandwidth estimation process uses the two last stored ACK packets.

In one aspect of the present invention, the principles of rate control for packet transmissions are applied to streaming video protocols. Such streaming video protocols attempt to maximize the quality of real-time video streams while simultaneously providing basic end-to-end congestion control. While several adaptive protocols have been proposed, a unique feature of a Video Transport Protocol (VTP) is the use of receiver-side bandwidth estimation. Such estimation is transmitted to the source and enables the source to adapt to network conditions by altering the source's sending rate and the bitrate of the transmitted video stream. VTP delivers consistent quality video in moderately congested networks and fairly shares bandwidth with TCP in all but a few extreme cases.

UDP is the transport protocol of choice for video streaming platforms mainly because the fully reliable and strict in-order delivery semantics of TCP do not suit the real-time nature of video transmission. Video streams are loss tolerant and delay sensitive. Retransmissions by TCP to ensure reliability introduce latency in the delivery of data to the application, which in turn leads to degradation of video image quality. Additionally, the steady state behavior of TCP involves the repeated halving and growth of its congestion window, following the well known Additive Increase/Multiplicative Decrease (AIMD) algorithm. Hence, the throughput observed by a TCP receiver oscillates under normal conditions. This presents another difficulty since video is usually streamed at a constant rate (in contrast, VTP streams are actually piecewise-constant). In order to provide the best quality video with minimal buffering, a video stream receiver requires relatively stable and predictable throughput not available from conventional TCP.

One characteristic of VTP is adaptation of an outgoing video stream to the characteristics of the network path between sender and receiver. If a VTP sender determines there is congestion, the VTP sender reduces its sending rate and the video encoding rate to a level the network can accommodate. This enables a VTP sender to deliver a larger portion of the overall video stream and to achieve inter-protocol fairness with competing TCP traffic. Another characteristic of VTP is the minimal use of network and end system resources. A VTP sender makes several trade-offs to limit processing overhead and buffering requirements in the receiver. In general, a VTP sender sparingly uses bandwidth and memory during the streaming session.

In essence, the VTP sender asks the receiver the question “are you receiving at least as fast as I am sending?” If so, the sender increases its rate by a small amount to probe the network for unused bandwidth. If not, the sender immediately reduces its rate by an amount based on the receiver's bandwidth, the current sending rate and video bitrate.

Another aspect of VTP is that it employs end-to-end metrics. VTP does not rely on Quality of Service (QoS) functionality in routers, Random Early Drop (RED), or other Active Queue Management (AQM) or Explicit Congestion Notification (ECN).

VTP is implemented entirely in user space and designed around open video compression standards and codecs for which the source code is freely available. The functionality is split between two distinct components, each embodied in a separate software library with its own API. The components can be used together or separately, and are designed to be extensible. VTP sends packets using UDP, adding congestion control at the application layer.

Although a VTP sender decreases its sending rate in response to packet loss, the decrease decision, as will be shown later, does not assume that all packet loss is a result of overflowed router buffers. At the same time, the amount of decrease is sufficient to restrict the sending rate to within the VTP sender's fair share of the network bandwidth. VTP uses additive increases in sending rates, but uses a rate estimation based decrease instead of a multiplicative decrease.

The MPEG-4 video compression specification is an open standard to encourage interoperability and widespread use. MPEG-4 has enjoyed wide acceptance in the research community as well as in commercial development owing to its high bitrate scalability and compression efficiency. Packetization markers in the video bitstream are another feature that make MPEG-4 especially attractive for network video transmission. Like other MPEG video compression tech-niques, MPEG-4 takes advantage of spatial and temporal redundancy in individual frames of video to improve coding efficiency. A unique capability of MPEG-4 is support for object-based encoding, where each scene is decomposed into separate video objects (VOs). A typical example of the use of object based encoding is a news broadcast, where the news person is encoded as a separate foreground VO while the background images compose another object. VO motion is achieved by a progression of Video Object Planes (VOPs).

There are three different types of VOPs in the MPEG-4 format: Intra-coded VOPs (I-VOPs) that are encoded independently and can be considered “key” VOPs; (2) Predicted VOPs (P-VOPs) that depend on preceding I-VOPs or P-YOPs and contain predicted motion data and information about the error in the predicted values; and (3) Bi-directionally predicted VOPs (B-VOPs) that depend on both previous and next VOPs. A sequence of VOPs is known as a Group of Video Object Planes (GOV). If a VOP upon which other VOPs depend is damaged during network transmission, decoding errors will manifest in the damaged VOP as well as all its dependent VOPs, a phenomenon known as propagation of errors. The MPEG-4 standard, RFC 30162, describes a structured packetization scheme that improves error resiliency, making error concealment and error recovery more effective to counteract error propagation.

The fundamental processing unit in MPEG-4 is a 16×16 block of pixels called a macroblock. A typical VOP is composed of rows of macroblocks called slices. Macroblocks from I-, P-, and B-VOPs contain different kinds of data that reflect the particular dependency relationships of the VOPs. A Discrete Cosine Transform (DCT) is applied to each macroblock, and the resulting 16×16 matrix is then quantized. The range of the Quantization Parameters (QPs) is normally from 1 to 31. with higher values indicating more compression and lower quality. Ultimately, the bitrate of an MPEG-4 video stream is governed by the quantization scale of each DCT transformed macroblock.

This object based encoding structure may be explointed by using network feedback to choose different quantizers for each VOP in real time. Foreground (more important) and background (less important) VOPs are weighted unequally, with QP values selected so that the quality of the background VOP is sacrificed first in times of congestion. The ranges of all quantizer values are such that the sum of bitrates of all the VOP streams equals the target bitrate of the whole video stream.

In contrast, VTP achieves adaptivity through a less complex approach with considerably looser semantics and lighter processing requirements. VTP is founded on the technique of discrete video encoding, where each video level is independent of the others. Each frame in the discrete encoded stream consists of only one rectangular VOP of fixed size; which implies a one to one correspondence between VOPs and frames. In this sense, the MPEG-4 codec in VTP performs like a conventional frame-based encoder.

The VTP sender determines from which discrete stream to send video data based on receiver feedback, and sends from that level exclusively until a decision is made to change. The QPs across all frames in a single level are all within a predefined range and the frame pattern is the same in every level. In effect, VTP adapts to one of the pre-encoded quantization scales in the video source instead of computing the quantizers in real time during the streaming session.

A typical video streaming server sends video data by dividing each frame into fixed size packets and adding a header containing, for example, a sequence number, the time the packet was sent, and the relative play out time of the associated frame. Upon receiving the necessary packets to re-assemble a frame, the receiver buffers the compressed frame for decoding. The decompressed video data output from the decoder is then sent to the output device. If the decoder is given an incomplete frame due to packet loss during the transmission, it may decide to discard the frame. The mechanism used in the discarding decision is highly decoder-specific, but the resulting playback jitter is a universal effect. As predicted frames depend on key frames, discarding a key frame can severely reduce the overall frame rate.

One aspect of VTP is adaptation of the outgoing video stream so that, in times of network congestion, less video data is sent into the network and consequently fewer packets are lost and fewer frames are discarded. VTP rests on the underlying assumption that the smooth and timely play out of consecutive frames is central to a human observer's perception of video quality. Although a decrease in the video bitrate noticeably produces images of coarser resolution, it is not nearly as detrimental to the perceived video quality as inconsistent, start-stop play out. VTP capitalizes on this idea by adjusting both the video bitrate and sending rate during a streaming session. In order to tailor the video bitrate, the same video sequence is pre-encoded at several different compression levels. By switching between levels during the stream, VTP makes a fundamental trade-off by increasing the video compression in effort to preserve a consistent frame rate at the client.

In addition to maintaining video quality, another feature of VTP is inter-protocol fairness. Unregulated network flows pose a risk to the stability and performance of the Internet in their tendency to overpower TCP connections that carry the large majority of traffic. While TCP halves its window in response congestion, unconstrained flows are under no restrictions as to the amount of data they can have in the network at any time. VTP's adaptivity attempts to alleviate this problem by interacting fairly with any competing TCP flows.

The principal features of this design, each described in the following subsections, can be summarized as follows:
Communication between sender and receiver is a “closed loop,” i.e. the receiver sends acknowledgments to the sender at regular intervals.
The bandwidth of the forward path is estimated and used by the sender to detemline the sending rate.
VTP is rate based. There is no congestion window or slow start phase.

VTP follows a client/sever design where the client initiates a session by requesting a video stream from the server. Once several initialization steps are completed, the sender and receiver communicate in a closed loop, with the sender using the ACKs to determine the bandwidth and RTT estimates.

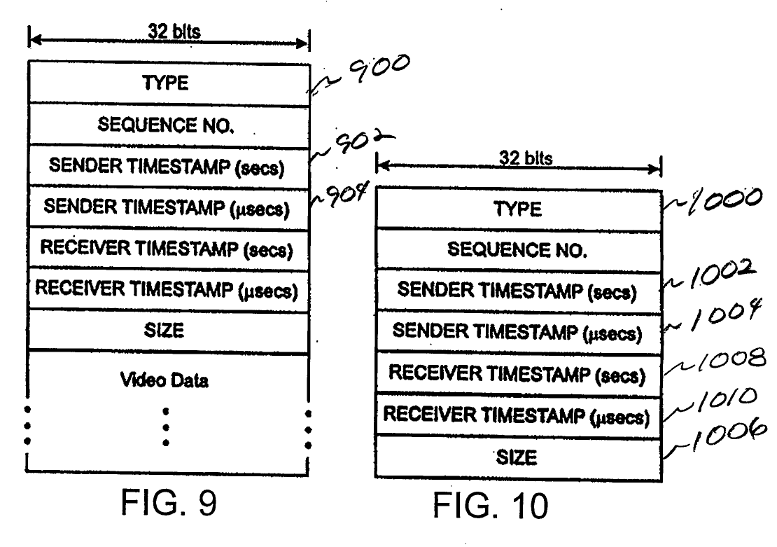

FIG. 9 illustrates a VTP video header in accordance with an exemplary embodiment of the present invention. FIG. 10 illustrates a VTP and acknowledgment or “control packet” format in accordance with an exemplary embodiment of the present invention. The symmetric design facilitates both bandwidth and RTT computation. Referring now to both FIG. 9 and FIG. 10, a TYPE field 900 and 1000 is used by the sender to explicitly request a control packet from the receiver. For every k video packets sent, the sender will mark the TYPE field with an ACK request, to which the receiver will respond with a control packet. The value of k is a server option that is configurable at run time by the user. The two timestamp fields for sender 900 and receiver 1000 respectively are used for RTT measurement and bandwidth computation. A VTP sender estimates the bandwidth available to it on the path and then calibrates its sending rate to the estimate, as detailed below.

When the receiver receives a data packet with the TYPE field indicating it should send a control packet, it performs two simple operations. First, it copies the header of the video packet and writes header timestamps 902 and 904 into appropriate timestamp fields 1002 and 1004 of the control packet. Second, the number of bytes received since the last control packet was sent is written into a SIZE field 1006. The modified video packet header is then sent back to the sender as a control packet.

Upon receipt of the control packet, the sender extracts the value in the SIZE field and receiver timestamps 1008 and 1010. The sender is able to compute the time delta between control packets at the receiver by keeping the value of one previous receiver timestamp in memory and subtracting it from the timestamp in the most recently received packet. The value of the SIZE field divided by this time delta is the rate currently being achieved by this stream. This rate is also the “admissible” rate since it is the rate at which data is getting through the path bottleneck. In essence, the measured rate is equal to the bandwidth available to the connection. Thus, it is input as a bandwidth sample into the bandwidth estimation algorithm described in the next section. The sender uses its own timestamps to handle the RTT computation. When the sender sends a video packet with the TYPE field marked for acknowledgment, it remembers the sequence number. If the sequence number on the returning control packet matches the stored value (recall the receiver simply copies the header into the control packet changing only its own timestamp and the SIZE field), the sender subtracts the sender timestamp in the control packet from the current time to get the RTT sample.

If either a data packet that was marked for acknowledgment or a control packet is lost, the sender notices a discrepancy in the sequence numbers of the arriving control packets. That is, the sequence numbers do not match those that the sender has recorded when sending out video packets with ACK requests. In this case, the sender disregards the information in the control packets. Valid bandwidth or RTT samples are always taken from two consecutively arriving control packets.

A bandwidth estimation bᵢ can be obtained by dividing the amount of data in the last k packets by the inter-arrival time between the current and k−1 previous packets in accordance with the following formula:

$${b}_{i} = \frac{{\sum }_{i = 1}^{k} {d}_{i}}{( {t}_{k} - {t}_{1} )} .$$

As a concrete example, suppose k=4 and four packets arrive at the receiver at times t₁, . . . , t₄ each with d₁, . . . , dᵣ bytes of data respectively. The sum

$${\sum }_{i = 1}^{4} {d}_{i}$$

is sent to the sender in the SIZE field of the control packet.

The sender, knowing t₁ from the last control packet and t₄ from the current control packet, computes bᵢ and then exponentially averages the samples using the following formula:

$${B}_{i} = α {B}_{i - 1} + ( 1 - α ) ( \frac{{b}_{i} + {b}_{i - 1}}{2} )$$

yields a bandwidth estimate Bᵢ; that is used by the sender to adjust the sending rate. The parameter α is a weighting factor that determines how much the two most recent samples should be weighed against the history of the bandwidth estimate. Base on experimental trials, VTP performs well when α is a constant close to 1. Packet loss is reflected by a reduction in the achieved rate and thus the bandwidth estimate. Since the bandwidth estimation formula takes into account losses due to both congestion and random errors, using an exponential average prevents a single packet drop due to a link error from causing a steep reduction in the estimate.

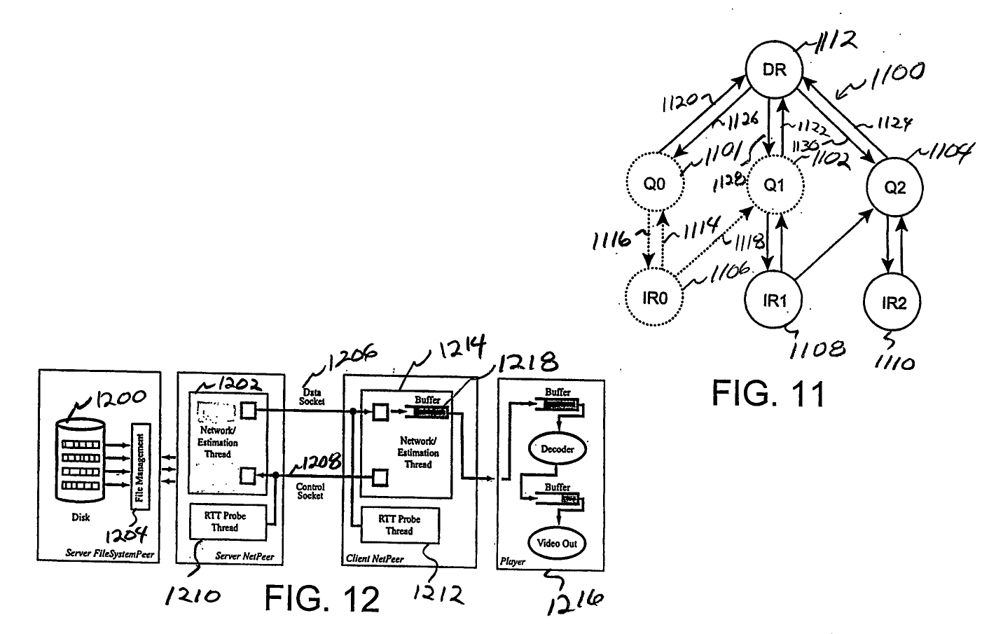

Through the estimate of the connection bandwidth, the VTP sender gains considerable knowledge about the conditions of the path. The sender uses the estimate as input into an algorithm that determines how fast to send the data packets and which pre-encoded video to send. FIG. 11 is a diagram of a sender Finite State Machine (FSM) controlling video rate transmission in accordance with an exemplary embodiment of the present invention. In the diagram, transitions involved in a video quality level increase are represented with dashed lines. In the FSM 1100, there are three video encoding levels; however, additional encoding levels may be accommodated by altering the FSM. The video encoding levels are represented by the states Q0 1101, Q1 1102, and Q2 1104 each corresponding to one distinct video encoding level from which the VTP sender can stream. Each IR state, IR0 1106, IR1 1108, and IR2 1110 represent Increase Rate states, and DR represents the decrease rate state.

Starting in state Q0, a transition (1114) to IRO is initiated by the reception of a bandwidth estimate that is equal to or greater than the current sending rate. Being in state Q0 only implies the VTP server is sending the lowest quality level, it says nothing about the sending rate. In state IRO, a VTP sender server checks several conditions. First, the sender checks if the RTT timer has expired. If it has not, the server returns (1116) to Q0 without taking any action and awaits the next bandwidth estimate. If one RTT has passed, the server remains in IR0 and investigates further. The server next determines whether the sending rate is large enough to support the rate of the next highest level (level 1 in this case). If not, the server increases the sending rate by one packet size and returns to state Q0. If. on the other hand, the sending rate can accommodate the next quality level, the server checks the value of a variable herein termed “the heuristic:”

The heuristic is meant to protect against over ambitiously increasing the video quality in response to instantaneous available bandwidth on the link that is short-lived and will not be able to sustain the higher bitrate stream. If the heuristic is satisfied, the server increases the sending rate by one packet size and transitions (1118) to state Q1. If the heuristic is not met, the server increases the rate by one packet and returns to state Q0. In normal operation, the server will cycle between states Q0 and IRO continually examining the RTT timer. the bandwidth estimate. and the heuristic, and adjusting the sending rate. When conditions permits, the transition to Q1 occurs. The process repeats itself for each of the quality levels such as Q2.

In one embodiment of the invention, the heuristic is an amount of time, measured in units of RTT, to wait before switching to the next higher level of video quality. Ideally, the heuristic also takes into account the receiver buffer conditions to ensure a video quality increase would not cause buffer overflow. Since the receiver is regularly relaying timestamp information to the sender, it is expedient to notify the sender of the amount of buffer space available in the control packet. The sender is then able to make the determination to raise the video quality with assurance that both the network and the receiver can handle the data rate increase.

In a rate and quality decrease, a transition (1120, 1122, or 1124) to DR is initiated when the VTP sender server receives a bandwidth estimate less than a current sending rate. In DR, the server checks the reference rate of each constituent quality, Q0, Q1, or Q2, to find the highest one that can fit within the bandwidth estimate. The server sets its sending rate to the bandwidth estimate and transitions (1126, 1128, or 1130) to the state corresponding to the video quality that can be supported. Unlike the state transitions to increase quality levels, the decrease happens immediately, with no cycles or waits on the RTT timer. This conservative behavior contributes greatly to the inter-protocol fairness properties of VTP.

As the FSM suggests, the selection of the encoding bitrates is important. VTP observes the rule that a particular video encoding level is transmitted at a rate greater than or equal to the encoding level's bitrate and does not send slower than the rate of the lowest quality encoding. This could potentially saturate the network and exacerbate congestion if the lowest video bitrate is frequently higher than the available bandwidth. Additionally, if the step size between each reference rate is large, more data buffering is required at the receiver. This follows from the fact that large step sizes lead to the condition where VTP is sending at a rate that is considerably higher than the video bitrate for long periods of time.

The stability of the Internet depends on the window based AIMD algorithm of TCP. Any protocol that does not observe the AIMD scheme requires justification to be considered viable, especially for large-scale deployment. VTP has no congestion window, does not perform slow start, and does not halve its sending rate on every packet loss. However, VTP uses resources in a minimal way and relinquishes them on the first indication of congestion. Justification for the plausibility of VTP is based mainly on the practical observation that the threat to Internet stability is not posed by flows using congestion control schemes that are non-compliant to AIMD, but rather by flows under no end-system control at all as such flows are completely impervious to network conditions.

It has not been proven that Internet stability requires AIMD, but some form of end-to-end congestion control is necessary in order to prevent congestion collapse. Even though VTP is not founded on AIMD, it is still able to fairly share links with TCP competitors as evidenced by experimental results. Inter-protocol fairness of VTP notwithstanding, any end-to-end mechanism that limits the flow of the real-time traffic in an environment where it competes with TCP is advantageous from the perspective of fairness. Furthermore, unlike TCP, VTP is aimed at preserving minimum variance in delivery rate at the receiver. Streaming applications that eschew TCP due to its oscillatory steady state nature can benefit from the smooth delivery rate of VTP while during times of congestion their data load on the network will be judiciously constrained.

By default, VTP performs a type of congestion avoidance: namely it increases its rate by a small amount on every estimated RTT. Normally, the rate increase is one packet size per RTT, but it can be tuned to compensate for large RTTs. The gradual rate increase seeks out available bandwidth and enables VTP to “ramp up” the video quality if network conditions remain accommodating. This behavior parallels the additive increase phase of AIMD so that rate increases in VTP and TCP are comparable.

Throughout the duration of the connection, a VTP process estimates the forward path bandwidth. If the bandwidth estimate falls below the sending rate, a VTP sender takes this as an indication of network congestion and reduces its transmission rate. In summary, the protocol behaves conservatively by slightly increasing the send rate every RTT and cutting the rate immediately upon the arrival of “bad news” indicating network congestion.

FIG. 12 is a software architecture diagram of a VTP sender and receiver in accordance with an exemplary embodiment of the present invention. The VTP implementation accepts standard Audio/Video Interleaved (AVI) files 1200 as input. For each video segment, a VTP process uses multiple AVI files, each representing a different level of MPEG-4 compression. Two main functional units comprise the VTP architecture. A transport layer component called NetPeer provides an interface that returns an estimate of the bandwidth share of the connection. A middleware component called FileSystemPeer 1204 manages the source video data and determines the sending rate based on the estimate provided by NetPeer.

For each set of AVI files, a binary file is created that contains the discrete encoded video along with synchronization markers to guide the server in selecting the right frame when a level change needs to be made. Upon receiving the client's request to start a stream, the FileSysternPeer opens the binary file and begins to send data at the lowest quality encoding. As the session progresses, the FileSystemPeer changes the video level in response to the NetPeer feedback.

The client and server communicate over two separate sockets: one UDP socket for data 1206, one UDP socket for control information 1208. Timestamps are gathered using a Berkeley Packet Filter utility (BPF) running in a separate thread 1210 and 1212 to minimize the influence of data processing on a RTT value. The BPF allows the user mode player and server processes to collect timestamps at the network interface level that exclude the operating system and protocol overhead time. The minimum measured RTT during the connection is used as the RTT value in the rate adjustment algorithm. Each of the two server components of VTP is independent and could potentially be used with other software modules. Similarly, the client NetPeer 1214 is intended to function as a generic plug-in to any software player 1216 that supports modular input.

A VTP software server may be implemented easily by linking the FileSystemPeer and NetPeer modules and providing a main routine to form an executable. The client side NetPeer includes buffering capability 1218 to accommodate network level buffering of video data.

The FileSystemPeer API provides two major functions:

is_eof=get Packet (qual, buffer, size); and

rate=setRate(rtt_val, bw_est. &qual);

The getpacket function fills the buffer field with a header and size bytes of video data from video quality qual, where qual corresponds to one of the pre-encoded compression levels in the binary file. A flag indicating if this is the last packet in the file is returned. The setrate function realizes the algorithm for setting the transmission rate. The values for the parameters rtt_val and bw_est are provided by NetPeer. The last parameter, qual, is passed by reference and is set by the setrate function and used as input in the next call to getpacket. It should be noted that both getpacket and setRate maintain state between calls.

The NetPeer API provides three functions:

bw_est=getBWE( );

rtt_val=getRTT( );

sendData(rate, buffer);

The sender uses getBWE to get the latest bandwidth estimate from its NetPeer. Internally, NetPeer performs non- blocking reads on the control socket to obtain the latest acknowledgment from the receiver. From the information in the ACK, it computes a bandwidth estimate which is the return value of the function. The sending rate can then be computed by calling the setrate function of the FileSystemPeer with the bandwidth estimate as the second parameter. GetRTT returns the latest value of the RTT estimate. The sendData function determines the amount of time to wait from the rate parameter, and then sends the buffer containing the header and video data.

In addition to these exported functions, several other functions are provided to handle connection initiation, opening the source video files, and other initialization tasks. These functions are straightforward and omitted for brevity. The k parameter, the value of the heuristic variable (in units of RTT), and the port numbers that VTP uses are all user configurable.

In a constant bitrate (CBR) video source, the quantization parameters are continuously adjusted to maintain the target bitrate of the overall video stream. This is beneficial for network transmission, but leads to varying video quality from frame to frame and can have an unpleasant effect on the viewer's perception. MPEG-4 preserves consistent quality by increasing the bitrate at times of high motion or detail, producing a Variable BitRate (VBR) encoding. In some instances the bitrate can change dramatically during the course of a video clip. The amount of rate variability is codec-dependent. VTP works best with a codec that does not skip frames to affect the level of compression, such is the case with DivX and FFmpeg.

Since it would be ineffective to transmit video data at uneven, bursty rates, VTP includes a method for determining a transmission schedule for VBR MPEG-4 video that leads to a piecewise-constant nominal sending rate. By taking advantage of a priori knowledge of the bitrates of the stored video files, the peak bandwidth requirements and rate variability of the transmission can be significantly reduced. An appropriate sending rate can be incrementally computed by averaging the video bitrate over discrete intervals.

Let V(t) represent the cumulative amount of bytes consumed by the client from the start of the streaming session to time t. In other words, if the video is encoded at a variable rate v(τ),

$$V ( t ) = {\sum }_{τ = 0}^{t} ( τ )$$

As a starting point for a constant rate transmission plan, let C(t) be the cumulative amount of bytes received at the client under a very simple CBR schedule: the constant rate equal to the size of the entire video segment (in bytes) over the duration.

It is useful to consider the difference between C(t) and V(t), or:
U(t)=C(t)−V(t)
to determine buffering requirements. Intuitively, U(t₀)<0 for a particular to signifies that transmitting the video stream at simply the average bitrate of the entire segment would lead to buffer underrun at time t₀. The maximum positive value of U(t) corresponds to the largest buffer occupancy in bytes under the same constant transmission rate.

A straightforward generalization of this approach involves shortening the interval over which the average is taken, and connecting several CBR “runs” to form a sequence of transmission rates. The use of ten segments in particular was found in experimental trials to be a good compromise between the length and number of separate intervals. Under this plan, the sender adjusts its sending rate ten times during the course of the stream. Each sending rate is exactly the slope of the line segment for the corresponding interval.

This technique may be extended to optimize the transmission schedule to ensure minimal use of receiver memory for video data buffering. Given the consumption rate V(t) and a buffer size b at the client, a successful transmission rate would deliver at least V(t) but not more than V(t)+b bytes to the client at any time t.

To find the minimum b required for a particular video stream while protecting against buffer underruns, consider again the function U(t) from above. The maximum of U(t) is the amount of data that the piecewise-constant rate plan will send ahead of the consumption rate. The client allocates a buffer of at least max U(t) bytes of data to avoid data loss because of overflowing buffers. The minimum value of U(t) corresponds to the greatest difference between the consumption rate and the server sending rate, i.e., the point where the sender falls most behind the receiver.

If |minU(t)| bytes could be transmitted before the time at which minU(t) occurs, underruns would be prevented. Suppose that a time tⱼ is chosen such that |min U(t)| bytes of data is sent in the time interval [0, tⱼ] in addition to the amount of data that needs to be sent under the constant rate plan. This way, |minU(t)|/tⱼ bytes/second to the rate computed by the piecewise-constant method to all the rates that lie in the interval [0, tⱼ].

In the worst case, time tⱼ can fall precisely when U(t) is at its maximum. The client would then have to be able to buffer both the maximum of U(t) and |minU(t)| at the instant tⱼ. Hence, if a bₘᵢₙ byte buffer is allocated at the client, where:
bₘᵢₙ=|maxU(t)|+|minU(t)|

both underruns and overruns will be prevented. The time tⱼ is chosen before the time that minU(t) occurs, but ideally it before the time of the first negative value of U(t).

In general, choosing a suitable tⱼ depends on the size of |minU(t)| and the time at which minU(t) occurs. If |minU(t)| is large, some care must be taken so that tⱼ is not too small. That is, the additional bytes that need to be sent are spread out over time and not sent in a burst at the beginning of the stream.

With discrete encoding, each video is stored on disk as several distinct streams differing in their level of compression. Each stream has an associated bₘᵢₙ and the transition points between segments occur at the same time points in each level. The bₘᵢₙ for the whole segment is simply chosen to be the maximum bₘᵢₙ of the constituent streams. Since the sending rates for all the video levels are pre-computed, this value of bₘᵢₙ is known before any video data is sent.

An alternative and often used approach to “pre-sending” extra bytes for protecting against underruns is to delay the initial playback at the client while it accumulates some amount of buffered video data. However, the video player usually has its own requirements for buffering in addition to buffering done at the network level. As can be seen in the architecture diagram of FIG. XX, the player buffers data between the codec and the video output system to synchronize the display of consecutive frames.

Buffers also need to absorb the small time scale rate changes because of variance in delay or “jitter.” Since VTP is designed modularly to operate with many video players, it does not place any restrictions on the player with regard to play out start time. VTP offers bₘᵢₙ as a guard against buffer overruns and underruns resulting from differences between the sending rate and consumption rate. As such, the decisions of exactly how much buffer space to allocate and when to start play out are left to the player.

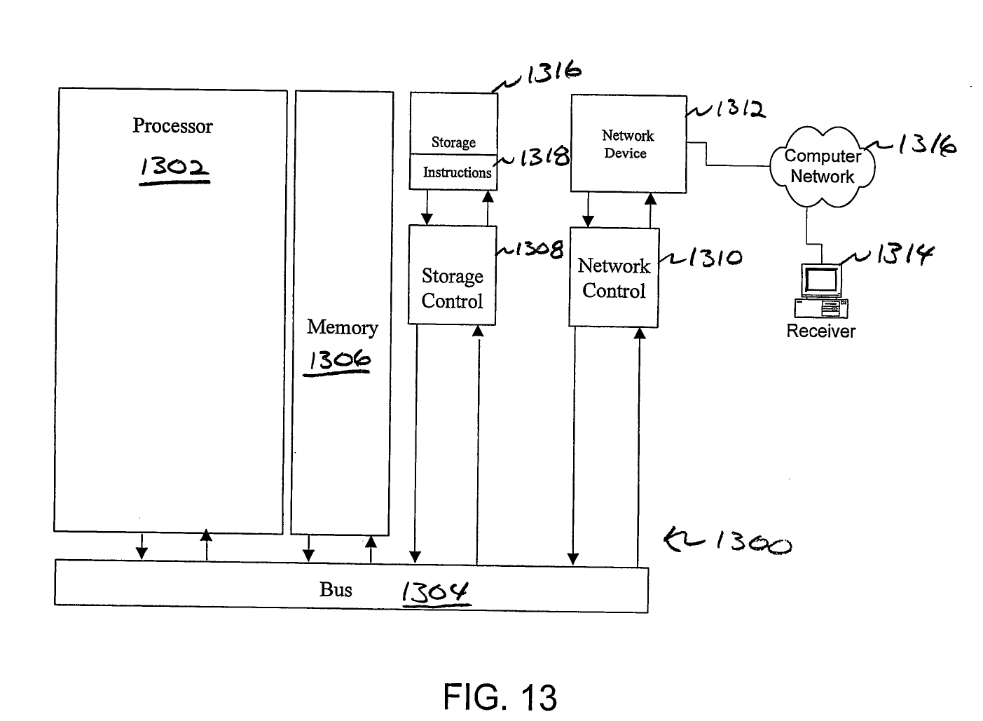

FIG. 13 is a block diagram of a data processing system suitable for hosting a TPC or VTP process in accordance with an exemplary embodiment of the present invention. A 1300 host includes a processor 1302 coupled via a bus 1304 to a memory device 1306, a storage device controller 1308, and a network device controller 1310. The processor uses the network device controller to control the operations of a network device 1312 which is adapted for communications using a transport protocol to transmit data to a receiver 1314 across a connection through a computer network 1316 such as the Internet.

The storage controller is coupled to a storage device 1316 having a computer readable storage medium for storage of program instructions 1318 executable by the processor. The program instructions are stored in the storage device until the processor retrieves the program instructions and stores them in the memory. The processor then executes the program instructions stored in memory to implement the transport protocol control process or video transport protocol as previously described.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by claims supported by this application and the claims' equivalents rather than the foregoing description.

What is claimed is:

1. A method of controlling a data transmission session by a sender to a receiver over a communications network, comprising:
receiving by the sender from the receiver via the communications network a plurality of data transmission acknowledgements;
generating by the sender a first connection rate estimate of network share using the plurality of acknowledgements; and
setting by the sender a data transmission control parameter using the first connection rate estimate.

2. The method of claim 1, wherein generating by the sender of a connection rate estimate further comprises:
generating a rate sample when an acknowledgement arrives using information in the acknowledgement regarding an amount of data received by the receiver data and an acknowledgement inter-arrival time; and
exponentially averaging the rate sample with a previous rate sample to produce smoothed rate estimate using a filter with time varying coefficients.

3. The method of claim 1, further comprising
generating a second connection rate estimate by the sender;
determining by the sender a cause of packet loss using the first connection rate estimate and the second connection rate estimate; and
setting by the sender a congestion window and a slow start threshold control parameter using the determination of the cause of packet loss.

4. The method of claim 3, wherein determining by the sender a cause of packet loss further comprises:
calculating a ratio of expected throughput to achieved throughput;
determining the cause of packet loss to be from congestion if the ratio exceeds a threshold value; and
determining the cause of packet loss to be from data transmission errors if the ratio of expected to achieved throughput is below the threshold value.

5. The method of claim 3, wherein the first connection rate estimate is a bandwidth estimate, the method further comprising:
generating a plurality of bandwidth samples using acknowledginent pairs taken from the plurality of acknowledgements; and
generating the bandwidth estimate using a low pass filter and the plurality of bandwidth samples

6. The method of claim 3, wherein the first connection rate estimate is a rate estimate, the method further comprising:
generating a plurality of rate estimates using amounts of data acknowledged during sampled time intervals; and
generating the rate estimate by applying a low pass filter to the plurality of rate estimates.

7. The method of claim 6, further comprising adapting the sampled time intervals using a perceived network congestion level, the perceived congestion level determined from a difference between an expected throughput and an achieved throughput of data from the sender to the receiver.

8. The method of claim 6, further comprising setting the congestion window and the slow start threshold during startup of a connection between the sender and the receiver over the communications network.

9. The method of claim 1, wherein the data transmission session is for video data, the method further comprising:
establishing a data connection between the sender and the receiver via the communications network;
establishing a data control connection between the sender and the receiver;
transmitting by the sender to the receiver video data via the data connection; and
receiving by the sender from the receiver the acknowledgements via data control connection.

10. The method of claim 9, wherein the acknowledgements include data control packets, the method further comprising:
determining by the sender a bandwidth estimate using the data control packets; and
altering by the sender a data transmission rate and a bitrate of the transmitted video data.

11. A data processing apparatus for controlling a data transmission session by a sender to a receiver over a communications network, comprising:
a processor; and
a memory coupled to the processor, the memory having program instructions executable by the processor stored therein, the program instructions comprising:
receiving by the sender from the receiver via the communications network a plurality of data transmission acknowledgements;
generating by the sender a first connection rate estimate of network share using the plurality of acknowledgements; and
setting by the sender a data transmission control parameter using the first connection rate estimate.

12. The data processing apparatus of claim 11, wherein the program instructions for generating by the sender of a connection rate estimate further comprise:
generating a rate sample when an acknowledgement arrives using information in the acknowledgement regarding an amount of data received by the receiver data and an acknowledgement inter-arrival time; and
exponentially averaging the rate sample with a previous rate sample to produce smoothed rate estimate using a filter with time varying coefficients.

13. The data processing apparatus of claim 11, the program instructions further comprising
generating a second connection rate estimate by the sender;
determining by the sender a cause of packet loss using the first connection rate estimate and the second connection rate estimate; and
setting by the sender a congestion window and a slow start threshold control parameter using the determination of the cause of packet loss.

14. The data processing apparatus of claim 13, wherein the program instructions for determining by the sender a cause of packet loss further comprise:
calculating a ratio of expected throughput to achieved throughput;
determining the cause of packet loss to be from congestion if the ratio exceeds a threshold value; and
determining the cause of packet loss to be from data transmission errors if the ratio of expected to achieved throughput is below the threshold value.

15. The data processing apparatus of claim 13, wherein the first connection rate estimate is a bandwidth estimate, the program instructions further comprising:
generating a plurality of bandwidth samples using acknowledgment pairs taken from the plurality of acknowledgements; and
generating the bandwidth estimate using a low pass filter and the plurality of bandwidth samples

16. The data processing apparatus of claim 13, wherein the first connection rate estimate is a rate estimate, the program instructions further comprising:
generating a plurality of rate estimates using amounts of data acknowledged during sampled time intervals; and
generating the rate estimate by applying a low pass filter to the plurality of rate estimates.

17. The data processing apparatus of claim 16, the program instructions further comprising adapting the sampled time intervals using a perceived network congestion level, the perceived congestion level determined from a difference between an expected throughput and an achieved throughput of data from the sender to the receiver.

18. The data processing apparatus of claim 16, the program instructions further comprising setting the congestion window and the slow start threshold during startup of a connection between the sender and the receiver over the communications network.

19. The data processing apparatus of claim 11, wherein the data transmission session is for video data, the program instructions further comprising:
establishing a data connection between the sender and the receiver via the communications network;
establishing a data control connection between the sender and the receiver;
transmitting by the sender to the receiver video data via the data connection; and
receiving by the sender from the receiver the acknowledgements via data control connection.

20. The data processing apparatus of claim 19, wherein the acknowledgements include data control packets, the program instructions further comprising:
determining by the sender a bandwidth estimate using the data control packets; and
altering by the sender a data transmission rate and a bitrate of the transmitted video data.
